(19) United States
(12) Patent Application Publication
(10) Pub. No.: US 2002/0136509 A1
(43) Pub. Date: Sep. 26, 2002

(54) Laying of a cable within a duct

(76) Inventor: Fraser Murray Watson, Auckland (NZ)

Correspondence Address: YOUNG & THOMPSON, 745 SOUTH 23RD STREET 2ND FLOOR, ARLINGTON, VA, 22202

(21) Appl. No.: 09/913,288

(22) PCT Filed: Dec. 13, 2000
(86) PCT No.: PCT/NZ00/00251

(30) Foreign Application Priority Data
Dec. 13, 1999 (NZ) 501732

(51) Int. Cl. G02B 6/44; B65H 20/14

(52) U.S. Cl. 385/100; 226/7

(57) ABSTRACT

For a cable to be laid inside a duct, the invention teaches the addition of “scales”, projections, or roughening outwardly from the cable sheath to help a cable-laying procedure wherein the cable is carried through the duct, from all along its own length, by blown air emitted from behind. Substantial improvements in laying efficiency over existing blown air techniques, with less strain on the cable than if pulled by a winch, and reduced laying costs are claimed. Hence cables may be of lighter construction than that required for conventional laying procedures.

### FIELD

This invention relates to means for inserting elongated objects into ducts, tubes, or the like, and more particularly relates to apparatus and methods for laying cables, such as (but not limited to) fibre-optic communications cables using the blown fluid technique.

### BACKGROUND

The placement of conduits to move materials, electricity, or data from one place to another is characteristic of developed societies. Typically the conduit comprises a cable which for the purpose of this document is an elongated cylindrical carrier, which may carry suspensions or fluids such as water, gas, or a chemical (including petroleum refinery products) along pipes or tubes, or electric power or data in copper wires, and may include conduits adapted for the carriage of modulated light beams (fibre-optic cables). Although this specification concentrates on fibre-optic cables including very clear, full-length glass fibres developed for the carriage of data, its general principles may be applied to cables for other kinds of moved materials or electricity. At the present time, a large amount of fibre cable is being laid. Laying telecommunications cables often comprises firstly the placement of an outer duct within a trench dug in the ground, or suspended from overhead wires, or through channels included in a building. Secondly, that outer duct may carry one or more sub-ducts each of which generally comprises a pipe capable of accommodating one typically slightly flexible data cable, itself likely to hold from one to hundreds of pairs of insulated copper conductors, and/or from one to hundreds of separate fine, continuous glass rods (the fibres) each capable of carrying as much information as tens of thousands of copper conductor pairs; the capacity being dependent on the length and type of the fibres and on the optoelectronic devices used as interfaces at each end of each of the glass fibres.

Each data cable is introduced into the length of the sub-duct (herein often called a “duct”) by one or another means; prior art means mostly comprise either (a) pulling the data cable through the sub-duct by means of an attached rope or the like from the far end, or (b) “pushing” the data cable by means of a parachute-like device attached to its leading end and using fluid (compressed air) pressure to cause the parachute to advance along the sub-duct. This is commonly referred to as “blowing the cable through”. Sub-ducts, which are commonly made of plastic pipe, are used for convenience; they provide extra protection and allow any one cable to be installed or replaced without disturbing the remainder of the cables within the trench. Absence of a sub-duct leaves the relatively fragile and hard to repair conductors within the data cable more at the mercy of accidental damage.

It will be appreciated that ordinary pushing without the assistance of a moving fluid is ineffectual because the data cable bends a little and lodges in the sub-duct after perhaps a few meters have been introduced (let alone the kilometer or more that is often required) and does not glide along. It is likely that cable sheath against duct wall friction at bends is an eventual limit on the length of cable that can be pulled along a sub-duct. In general, one kilometer is a typical upper limit.

Referring to the prior art, Barker et al in U.S. Pat. No. 5,555,335 (to British Telecommunications Plc) describe a cable, in particular a fibre optics cable, wherein the surface of the cable is roughened by incorporation of particular foreign-body inclusions (for example glass beads or mica flakes) for the same purpose. However, the improvements were not large. Comparison of FIGS. 8 (control) and 7 (with added glass beads) reveals, once the scales of the graphs are taken into account, that addition of glass beads actually increases the time taken to lay 300 m of cable from 10 min (FIG. 8) to 15 min though the duct through which the test cable was blown was larger for the beaded fibre. On the other hand FIG. 12 shows a small extra force realised with the “SF 12 micro” and “mica flakes” treatments.

That air turbulence around a cable during laying may assist in reduction of friction is suggested by Flores Sr in U.S. Pat. No. 5,730,424 which describes a pulse-pressure type of valve to increase turbulence within a duct to which the valve is applied. However this does not describe a modification to the cable itself.

### OBJECT

It is an object of this invention to provide an improved form of cable capable of being fed into a sub-duct, and/or an improved method for feeding a cable into a sub-duct, or at least to provide the public with a useful choice.

### STATEMENT OF INVENTION

In a first broad aspect this invention provides an elongated cable adapted for being laid by blowing through a cable-carrying duct; the cable having a first or leading end, and having an outer sheath, the cable being capable of supporting an internal means for carriage of material or of data; wherein the profile of the surface of the outer sheath of the elongated cable is modified substantially along the length of the cable so as to form a plurality of surface projections protruding from the surface; the projections being capable of serving as bearing surfaces capable of at least partially supporting the weight of the cable during a blowing process, and also being capable of engaging with and agitating a current of a fluid used to blow the cable along the duct, so that the cable can be dragged along the duct by the current of fluid and so be passed into and laid more easily within the duct.

Preferably the internal means for carriage of material/data comprises at least one optical fibre. In a related aspect, the projections protrude radially out from, and in a plurality of directions from the surface of the outer sheath.

In another related aspect, each projection protrudes to an extent sufficient to effectively engage with a moving fluid passing along the duct toward the front end of the cable and over that length of the cable lying within the duct.

In a further related aspect each projection comprises a discrete surface modification, resembling a scale of a fish attached to the sheath at the leading edge of the scale; each scale being orientated so that the leading edge of each scale is orientated towards the leading end of the cable, and the projection is capable of being raised by the passage of a fluid toward the front of the cable.

Preferably each projection has sufficient strength in use to resist folding over by force applied by the moving fluid and sufficient strength to at least partially support an adjacent part of the cable above any surface that the projection may contact for the time being, so that each projection continues during use to effectively engage with the moving fluid.

Preferably also, the trailing edge of each projection is capable of acting as a rubbing surface having an effect of reducing friction occurring between the sheath of the cable and an adjacent surface (such as an internal wall of a sub-duct).

In a still further related aspect, the projections may be created by a process of cutting partially into the sheath of the cable and in a forwards direction.

Alternatively, the sheath surface may be provided with an array of projections by wrapping, in the form of an open helix, a band, having a cyclically varying thickness, around the cable. Optionally the direction or pitch of the band is reversed periodically.

In an even further related aspect the invention provides an elongated cable as previously described in this section wherein an amount of reinforcing means included within the cable is reduced in order to reflect the reduced laying stresses that such a cable will have to endure.

In a second broad aspect the invention provides a method for laying at least one cable as previously described in this section inside a duct at a time prior to installation of the duct, wherein the method includes the steps of taking a cable having surface projections, feeding the cable into the sub-duct while the sub-duct is in a storage configuration on a dispenser, and applying a flow of fluid from beside the cable into the duct while continuing to feed the cable into the duct, so that the relatively strong duct supports the at least one cable during installation.

In a third broad aspect the invention provides a method for laying an extended, unjoined length of cable as previously described in this section along a series of ducts joined end to end; the method involving means for handling cable at intermediate stations or manholes, wherein the method includes the steps of laying out the cable emerging from a first duct at a first manhole on a surface in a “figure-8” configuration as it emerges from being blown through the first duct, and is subsequently flipped over and fed along a second duct to a further intermediate station or manhole by a further blowing process using the figure 8 laid cable as a supply of cable.

Preferably a small amount of spare cable is retained at any intermediate station or manhole to cater for later connections.

### PREFERRED EMBODIMENT

The descriptions of the invention to be provided herein are given purely by way of example and are not to be taken in any way as limiting the scope or extent of the invention.

### DRAWINGS

FIG. 1: shows a surface view of a portion of a telecommunications cable in which a hand-made series of projections has been cut into the sheath (Example 1).

FIG. 2: shows a section of a paper tape bearing a series of prepared, stick-on projections which may be automatically or manually stuck onto a cable sheath (Example 4).

FIG. 3: shows a section of a sub-duct including a blown-in cable, and shows a mole plough laying sub-duct already provided with cable into the ground (Example 7).

FIG. 4: (as FIG. 4a, 4b, and 4c) shows the progress of a cable laying operation, involving figure-8 “coils” (Example 9).

### INTRODUCTION

In principle, the invention provides an elongated cable (as previously defined) wherein the outer sheath is modified to have—at least in part—projections which are intended to “catch” the fluid (typically compressed air) used when blowing a cable into a duct (or sub-duct) and which provide a significantly improved procedure for laying cables. Note that although the inventor believes that “engaging the cable with an abundant supply of moving air” is the essence of the operation of his invention, it is likely that other factors also play a part—including that there is a decreased plastics upon plastics friction between the sheath and the interior of the sub-duct (because of a reduced contact surface), and more “stirring” of the moving flow of air occurs about a cable (perhaps involving turbulence, or deliberately induced helical flow patterns) which may tend to raise the cable from contact with the duct wall, or perhaps particles of dust or the like tend to surround the cable rather than pass along beside it, and may act as “imperfect rollers”. The inventor believes that it is possible that turbulence with the flow of fluid as enhanced by the projections helps to agitate, and to suspend the cable within the sub-duct during laying and that this action assists in its enhanced forward movement during the laying process.

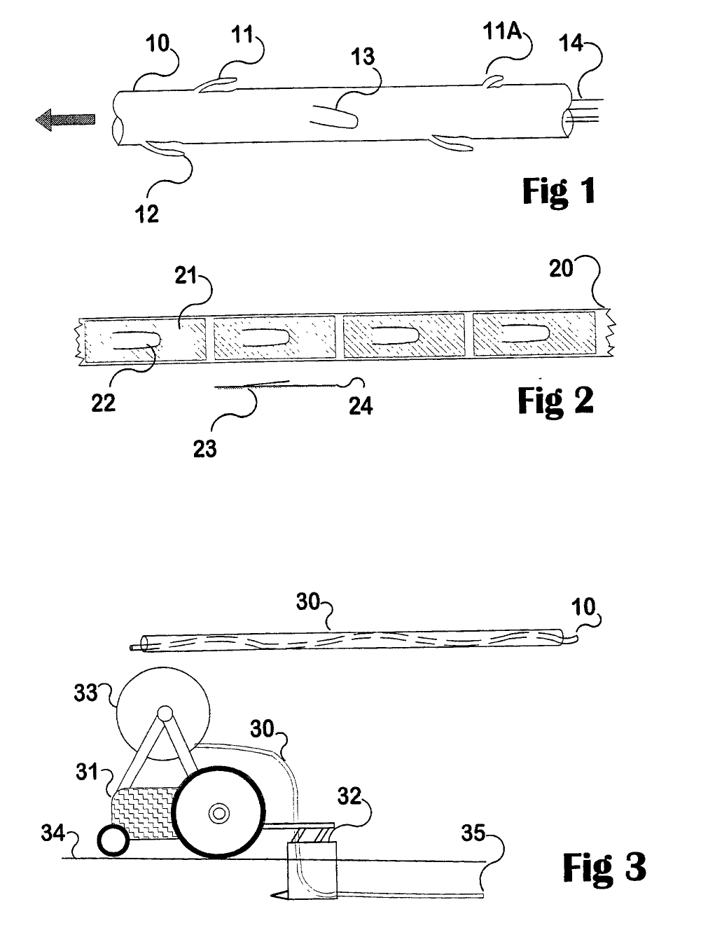

Projections 11, 12, 13 as shown in FIG. 1 emerge radially from the sheath of the cable 10; more specifically from the surface of the outer sheath, and in a plurality of directions. Note that FIG. 1 shows a few fibres 14 protruding from a cut end. In fact some sort of protective cap should be applied over the leading free end, to protect the interior of the cable from damage, and to protect workers near the far end of the sub-duct when the cable flies out. Note that 11A shows a more fish-scale like profile, in order to indicate that a variety of projection shapes may be functionally equivalent and ultimately, the shape that can be applied to a cable most cheaply may be preferred.

We have indicated that each projection is angled back from the intended direction of laying (movement of the cable 10 towards the left of the drawing), and emerges to an extent sufficient to interact with a moving fluid passing along the length of the cable in the same direction as the laying direction which is indicated in FIG. 1 by the cross-hatched arrow.

In accordance with the “reduction of friction” concept, which may be related to a reduced contact surface area, preferably each projection has sufficient strength to support an adjacent part of the cable against the force of gravity, so that the cable tends to ride along on the tips of the projections while being laid. For this purpose, the distal tips of the projections should be able to act as a rubbing surface, and for this purpose one further improvement may be to use a low-friction plastics material in at least the projections from the sheath (if not the entire sheath) so that friction is further reduced, (In FIG. 2 the stick-on patches may be made from a plastics material with a reduced coefficient of friction such as PTFE sold as Teflon(R)).

### EXAMPLE 1

(A Trial)

Our laying trial began with a relatively short trial length of cable, the sheath of which had been cut into with a knife along its length so that a series of spaced-apart “scales” each having a free end or tip pointing in substantially the same direction were created much as shown in FIG. 1—see 11 or 11A.

We refer to these projections as “fish-scale projections”, because any one projection resembles a lifted-up scale of a fish. There is a preferred direction of movement of the cable over the surface—away from the direction of the leading edge such that the scale tends to close with movement rather than be opened out. We use this modified cable in combination with the blown air method for pushing a cable along a duct. Our theory is that the projection is caught up by the flow of fluid (compressed air) from behind and hence the cable is pulled along the duct from a large number of points distributed along the entire length of the cable (or perhaps just the treated length, if only a “header” is so embellished with projections) of the cable, which substantially reduces stresses imposed on the cable and its contents during pulling over the prior-art “yank” technique (a pre-laid wire rope pulled along the sub-duct by a winch) or the use of a “parachute” with a compressed fluid.

The shape of each scale-type projection as constructed in this way is preferably such that it can engage with a flow of fluid from behind, assuming that our present theory concerning the basis of this invention is applicable. Possibly, sufficiently short projections can be used with a flow of fluid from either direction in order to cancel the minor objection that the cable can be laid in only one direction.

### EXAMPLE 2

Each projection may be formed at a slight angle so that air movement along the side of the sheath of the cable becomes at least partially helical. In order to stop the cable from twisting, by acting like a driven fan, it may be useful to reverse the direction of the angle periodically. Formation at an angle is simple; for example either the cuts of FIG. 1 are made at an angle (as indicated particularly with the projection 13), or the stick-on projections of FIG. 2/example 5 are applied onto the sheath of the cable at an angle.

### EXAMPLE 3

(A Manufactured Cable)

Each projection may be formed in some way during the process of cable manufacture, as for example when the sheathed cable emerges from an orifice of a sheath-applying stage of manufacture. At this point the sheath may be hot (or as yet incompletely cured) and softer, hence easier to embellish. (In contrast, the stick-on projections of FIG. 2/example 5 may be applied automatically at or about the time of laying the cable).

### EXAMPLE 4

(A Manufactured Cable)

One construction method that is compatible with known cable manufacturing techniques is to wrap, in an open helical manner, a thick, rigid band around the cable. Preferably that band has a cyclically varying thickness or its outer surface may be constructed to resemble as far as possible the projections of FIG. 1. Optionally the direction or pitch is reversed periodically so that the cable does not tend to twist about its length.

### EXAMPLE 5

(Applied Adhesive Projections)

Each projection may be formed by means of an externally applied material (see FIG. 2); for instance sticky plastics squares 21, supplied on a tape 20 and rolled onto the exterior of a cable at spaced-apart positions about the radius, either late in manufacture, or at some subsequent time. The advantage of this approach is that the material of which the projections 22 are made may be different to that of the actual sheath, and that the integrity of the sheath is not compromised at all. (Knife cuts may pose a risk). For instance, the sheath itself may be an impervious, cheap, tough, rubbery, and nondegradable material, while the stick-on projections may be made of a low-friction and relatively inelastic material. Conveniently, the projections themselves lack adhesive (shown as a shading 23 in FIG. 2). The side view of one projection is at 24.

### EXAMPLE 6

(Applied Knife Cuts)

Each projection may be formed by a mechanical operation on the existing sheath of the cable at some time after manufacture, perhaps by an automated version of the knife cuts described with reference to example 1, or an embossing roller

### EXAMPLE 7

(Method of Use)

A first method of laying a cable having added projections according to the invention is to treat it in a similar manner to cables blown into ducts as at present; however the “parachute” commonly used in cable laying (and believed by many to be indispensable) as a leading air catcher and dragging device may be dispensed with. Using the usual levels of air flow or lesser amounts, the modified cable is capable of advancing into and through the duct at a considerable rate.

Note that in the event of the sub-duct diameter being significantly larger than the cable diameter, it may at times be preferable to retain a parachute at the head in order that the leading end of the cable is held out straight or substantially so by the current of fluid. In the inventor's own experience so far this has not proven necessary.

### EXAMPLE 8

(Method; Preloaded Sub-duct)

A second method of laying a cable having added projections according to the invention is to blow it into a corresponding length of sub-duct while that sub-duct is still coiled on a dispenser such as a cable drum, prior to the sub-duct (or duct, as the case may be), being laid into a trench as cut by a mole plough 32 or the like. FIG. 3 illustrates a short example length of sub-duct 30 containing a length of cable 10. The cable is shown as having a sinusoidal arrangement, to provide for some slack to be taken up when the sub-duct is straightened out after laying by a mole plough 32 on the back of a tractor 31. Possibly this operation can be done at a depot, or at a factory, but more conveniently it is a useful alternative that can be done in the field as an adjunct to conventional laying within already-buried sub-ducts. For example, if one cable emerging from a manhole or the like is to be taken away from the course of a prepared main trench, it would be possible to recover that cable from a figure-8 layout on the ground and blow it into a subduct held on a dispenser (drum) on a tractor fitted with a mole plough, and then send that tractor off to lay the combination up to a selected destination.

### EXAMPLE 9

(Laying Method; Figure-8 Intermediate Steps)

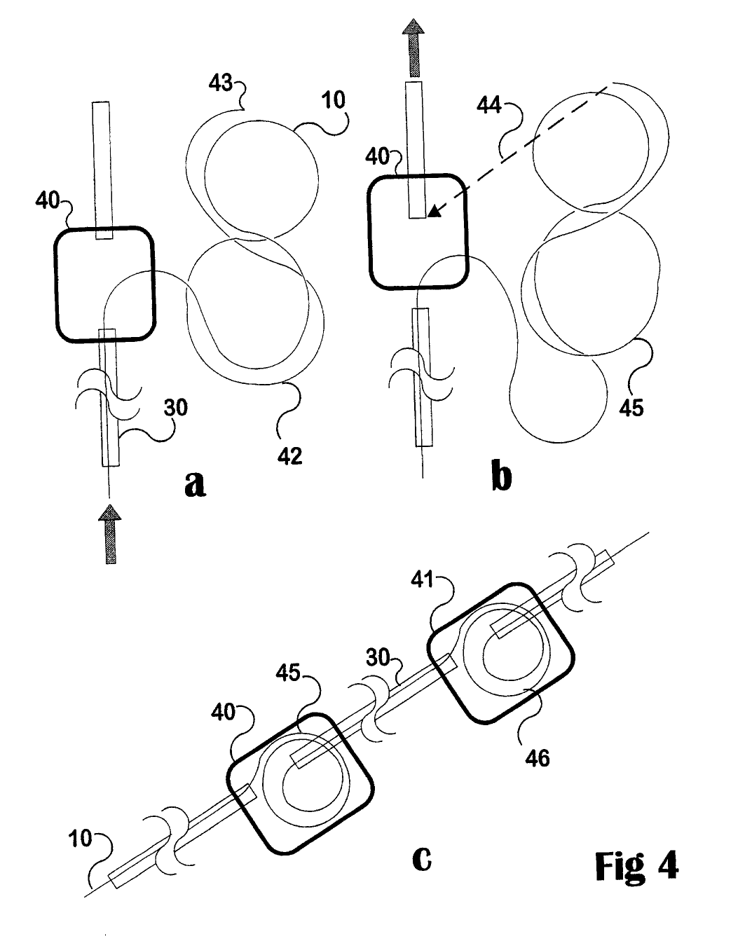

It will be appreciated that this procedure for enhancing the laying of cables, such as fibre-optic telecommunications cables, renders more feasible the possibility of laying a quite long cable from a source to a destination without breaking and rejoining the cable. Rejoining is a tedious, expensive process that inevitably degrades the optical performance of a fibre-optic cable. Accordingly we provide a method (see FIG. 4) for handling the cable at intermediate way-points (generally manholes 40, 41) so that the full length of cable can emerge from a first length of sub-duct 30 (typically of the order of one kilometer) and subsequently be blown into a second length, and so on, until the entire cable is in place. Given that there may be a subsequent requirement to tap into the cable at any one manhole, there will preferably be a coiled length of cable (46 in FIG. 4 c) left within each manhole. As the free end 43 of the cable 10 emerges from an open end of a sub-duct (FIG. 4a) it is transferred onto a surface (such as the ground) and is laid down in a figure-8 layout (42 in FIG. 4a) which has the particular advantages over simply rolling it up on a drum that (1) there is no imposed twisting effect and (2) by simply turning the mass of cable over (retaining the figure-8 shape perhaps by temporarily placing wraps about parts of the mass) the free end is ready to be picked up. After turning the “heap” of figure-8 configured cable over (45 in FIG. 4b) the free end 43 can be inserted 44 into the next portion of sub-duct or into a drum of sub-duct 33 intended for laying by mole plough, for the next stage of blowing. The direction of progress is indicated—as per FIG. 1—by the hatched broad arrow.

Variation 1

Each projection may have a shape slightly or even substantially unlike that of the fish-scale described within example 1. Variations on the shapes may be dictated more by an optimised method of manufacture, or of application, than on details such as aerodynamics, or frictional attributes.

Variation 2

Although our discussion of sub-ducts and the like has been in relation to laying in the ground, buildings, bridges, and the like may also be provided with equivalent paths for the laying of telecommunications cables. Indeed, fibre-optic devices are increasingly being used within a building as sensors for “smart structures” where for example the fibre itself is exposed over a defined portion to strain in a structure, and changes in optical properties of the fibre are used to sense movements of the structure. Cable and fibres to be used in this way are preferably laid out in a manner involving minimised likely or actual damage.

Variation 3

A telecommunications cable itself may now be optimised for a less stressful laying process, and be constructed with a lesser amount of longitudinal strengthening means, such as internal steel wires. Benefits may reside in reduced cost, reduced mass, and/or in increased space for data-carrying components such as more fibres.

Commercial Benefits of Advantages

The improved ability to lay fibre-optic cables according to this process translates into substantial savings by a number of avenues. Under the prior-art “pull” methods, the laying of a 10 kilometer length in an existing sub-duct in an existing trench involves: a $150,000 winch, a $50,000 compressor, a $80,000 jinker (cable drum supporter), 8 men, 2 trucks, a van, road cones and signs, and takes about 10 days to do the job. A manhole each kilometer is required (total 11) and at each manhole a cable jointing operation is required, which is technically complex and time-consuming. Each joint involves a loss of conductivity of light of about 3 dB, hence the light loss in any one fibre is a reduction of 512 times.

Under the present system, it may be possible to blow cable through the entire 10 kilometers in one pass. The winch, 6 men, up to 9 manholes, one truck, one van, and cable jointing equipment and time are no longer needed and the cable can be expected to reach the other end in less than half a day and in good condition; having been handled much more gently.

Alternatively, given that much of the mass of a cable is not optical fibre but supporting steel wires, tough sheathing and protective coatings, then it should be possible to downwardly optimise the required reinforcing structure—steel wires, bulk of plastics, and the like for this method of laying thereby producing cheaper, smaller, and lighter cables, more of which can be inserted into a given duct.

Although a number of preferred examples as described above have been disclosed for illustrative purposes, those skilled in the art will appreciate that various modifications, additions, and substitutions to the apparatus and methods described herein are possible without departing from the scope and spirit of the invention as set forth in the following claims.

1. An elongated cable adapted for being laid by blowing through a cable-carrying duct; the cable having a first or leading end, and having an outer sheath, the cable being capable of supporting an internal means for carriage of material or of data; characterised in that the profile of the surface of the outer sheath of the elongated cable is modified substantially along the length of the cable so as to form a plurality of surface projections protruding from the surface; the projections being capable of serving as bearing surfaces capable of at least partially supporting the weight of the cable during a blowing process, and also being capable of engaging with and agitating a current of a fluid used to blow the cable along the duct, so that the cable can be dragged along the duct by the current of fluid and so be passed into and laid more easily within the duct

2. An elongated cable as claimed in claim 1 characterised in that the internal means for carriage of material or of data comprises at least one optical fibre.

3. An elongated cable as claimed in claim 1 characterised in that the projections protrude radially out from, and in a plurality of directions from the surface of the outer sheath.

4. An elongated cable as claimed in claim 3 characterised in that each projection protrudes to an extent sufficient to effectively engage with a moving fluid passing along the duct toward the front end of the cable and over that length of the cable lying within the duct.

5. An elongated cable as claimed in claim 4 characterised in that each projection comprises a discrete surface modification, resembling a scale of a fish attached to the sheath at the leading edge of the scale; each scale being orientated so that the leading edge of each scale is orientated towards the leading end of the cable, and the projection is capable of being raised by the passage of a fluid toward the front of the cable.

6. An elongated cable as claimed in claim 5 characterised in that each projection has sufficient strength in use to resist folding over by force applied by the moving fluid and sufficient strength to at least partially support an adjacent part of the cable above any surface that the projection may contact for the time being, so that each projection continues during use to effectively engage with the moving fluid.

7. An elongated cable as claimed in claim 3 characterised in that the trailing edge of each projection is capable of acting as a rubbing surface having an effect of reducing friction occurring between the sheath of the cable and an adjacent surface.

8. An elongated cable as claimed in claim 7 characterised in that the projections are created by a process of cutting partially into the sheath of the cable and in a forwards direction.

9. An elongated cable as claimed in claim 3 characterised in that an array of projections is provided by wrapping, in the form of an open helix, a band, having a cyclically varying thickness, around the cable.

10. An elongated cable as claimed in claim 9 characterised in that the direction or pitch of the band is reversed periodically.

11. An elongated cable as claimed in claim 8 characterised in that an amount of reinforcing means included within the cable is reduced in order to reflect the reduced laying stresses that such a cable will have to endure.

12. A method for laying at least one cable as claimed in claim 8 inside a duct at a time prior to installation of the duct, characterised in that the method includes the steps of taking a cable having surface projections, feeding the cable into the sub-duct while the sub-duct is in a storage configuration on a dispenser, and applying a flow of fluid from beside the cable into the duct while continuing to feed the cable into the duct, so that the relatively strong duct supports the at least one cable during installation.

13. A method for laying an extended, unjoined length of cable as claimed in claim 8 along a series of ducts joined end to end; the method involving means for handling cable at intermediate stations or manholes, characterised in that the method includes the steps of laying out the cable emerging from a first duct at a first manhole on a surface in a “figure-9” configuration as it emerges from being blown through the first duct, and is subsequently flipped over and fed along a second duct to a further intermediate station or manhole by a further blowing process using the FIG. 8 laid cable as a supply of cable.
